(19) United States
(12) Patent Application Publication
(10) Pub. No.: US 2009/0193941 A1
(43) Pub. Date: Aug. 6, 2009

(54) Ratchet Wrench

(75) Inventors: Light Chiu, Taichung (TW); Robert St. John, Cheshire, CT (US)

Correspondence Address: PILLSBURY WINTHROP SHAW PITTMAN, LLP, P.O. BOX 10500, MCLEAN, VA, 22102, US

(73) Assignee: THE STANLEY WORKS, New Britain, CT (US)

(21) Appl. No.: 12/027,099

(22) Filed: Feb. 6, 2008

(51) Int. Cl. B25B 13/14; B25B 13/46

(52) U.S. Cl. 81/165; 81/179; 81/186

(57) ABSTRACT

A wrench adapted to engage a workpiece to drive the workpiece rotationally. In one embodiment, the wrench comprises a handle, a head, a first jaw, a track, a second jaw, and a biasing member. The first jaw is disposed on the head such that the position of the first jaw is adjustable toward and away from the jaw support along a first path, thereby enabling the wrench to be adapted for engagement with workpieces of different sizes. The second jaw is slidably seated in the track formed on the jaw support to slide along a second path between a first position and a second position. The second jaw further cooperates with the first jaw to grasp a workpiece therebetween and drive the workpiece in a first rotational direction if the head is driven in the first rotational direction by the handle. If the head is driven by the handle in a second rotational direction the engagement between the second jaw and the workpiece applies a force to the second jaw that slides the second jaw from the first position toward the second position, which enables the head to be rotated independently from the workpiece in the second rotational direction

### RELATED APPLICATIONS

The instant application is related to U.S. patent application Ser. No. ______ (Attorney Docket No. 081712-0366902), which is entitled “Ratchet Wrench,” and has been filed concurrently with the instant application. The contents of the related application are hereby incorporated by reference into the instant application.

### FIELD OF THE INVENTION

The invention relates to ratchet wrenches, including ratchet wrenches that are open-ended and/or adjustable to engage workpieces with different sizes.

### BACKGROUND OF THE INVENTION

Various ratchet wrenches are known. However, most ratchet designs are for closed-end wrenches, wrenches that encompass the circumference of a workpiece. In some circumstances, due to tight working quarters for example, use of a closed-end wrench to drive a workpiece may be precluded. As an alternative to a closed-end wrench, an open-ended wrench may be used.

While some designs for open-ended ratchet wrenches exist, these designs may be expensive to manufacture, be prone to breakage, not ratchet smoothly, and/or suffer from other drawbacks. Further, these types of wrenches are usually adapted for use with workpieces of a single size. Thus, in order to drive workpieces of different sizes with an open-ended ratchet wrench, a user will typically be required to use a plurality of different wrenches (with each wrench corresponding to a certain workpiece size).

### SUMMARY

One aspect of the invention is related to a wrench adapted to engage a workpiece to drive the workpiece rotationally. In one embodiment, the wrench comprises a handle, a head, a first jaw, a track, a second jaw, and a biasing member. The head is disposed at one end of the handle, the head having a jaw support extending therefrom. The first jaw is disposed on the head and forms a first workpiece engaging surface. More particularly, the first jaw is disposed on the head such that the position of the first jaw is adjustable toward and away from the jaw support along a first path, thereby enabling the wrench to be adapted for engagement with workpieces of different sizes. The track is formed on the jaw support. The second jaw is slidably seated in the track formed on the jaw support to slide along a second path between a first position and a second position, the first position being closer to the handle than the second position and the second path being transverse to the first path. The biasing member biases the second jaw toward the first position. The second jaw further forms a second workpiece engaging surface that cooperates with the first workpiece engaging surface to grasp a workpiece therebetween and drive the workpiece in a first rotational direction if the head is driven in the first rotational direction by the handle. If the head is driven by the handle in a second rotational direction the engagement between the second jaw and the workpiece applies a force to the second jaw that slides the second jaw from the first position toward the second position, which enables the head to be rotated independently from the workpiece in the second rotational direction.

Another aspect of the invention relates to a wrench adapted to engage a workpiece to drive the workpiece rotationally. In one embodiment the wrench comprises a handle, a head, a first jaw, a slot, a conduit, a pin, a second jaw, and a biasing member. The head is disposed at one end of the handle and has a jaw support extending therefrom. The first jaw is disposed on the head and forms a first workpiece engaging surface. The slot is formed in a surface of the jaw support. The conduit is formed in the jaw support on each side of the slot such that the conduit creates a passage from one side of the jaw support to another side of the jaw support, the passage communicating with the slot. The pin is seated in the conduit formed in the jaw support and passes transversely through the slot. The second jaw has a tab with an opening formed therein, the tab of the second jaw being seated in the slot formed on the jaw support such that the pin passes through the opening formed in the tab to retain the tab within the slot, wherein the opening is formed in the tab to enable the second jaw to slide along the jaw support between a first position and a second position, the first position being closer to the handle than the second position. The biasing member biases the second jaw toward the first position. The second jaw forms a second workpiece engaging surface that cooperates with the first workpiece engaging surface to grasp a workpiece therebetween and drive the workpiece in a first rotational direction if the head is driven in the first rotational direction by the handle. If the head is driven by the handle in a second rotational direction, the engagement between the second jaw and the workpiece applies a force to the second jaw that slides the second jaw from the first position toward the second position, which enables the head to be rotated independently from the workpiece in the second rotational direction.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a wrench, according to one embodiment of the invention.

FIG. 2 illustrates an exploded view of a head of a wrench, in accordance with one embodiment of the invention.

FIG. 3 illustrates a section view of a head of a wrench, according to one embodiment of the invention.

FIG. 4 illustrates a wrench driving a workpiece, according to one embodiment of the invention.

FIG. 5 illustrates a wrench ratcheting about a workpiece, according to one embodiment of the invention.

### DETAILED DESCRIPTION

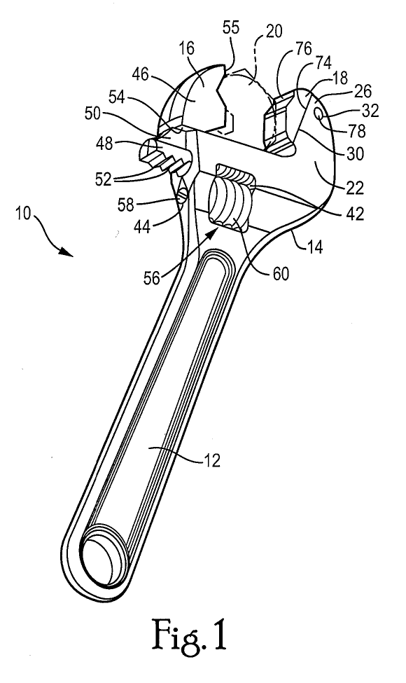

FIG. 1 illustrates a wrench 10 according to one or more embodiments of the invention. Wrench 10 includes a handle 12, a head 14, a first jaw 16, and a second jaw 18. First and second jaws 16 and 18 are configured to engage the head of a workpiece 20 to rotationally drive the workpiece 20 as head 14 is driven by a user to rotate around workpiece 20 in a first direction (counter-clockwise in FIG. 1). As can be seen in FIG. 1, wrench 10 is an “open-end” wrench, which may enable wrench 10 to engage workpieces in some circumstances in which the use of a “closed-end” wrench (e.g., a box-end wrench, a socket wrench, etc.) is inhibited. As is discussed further below, first jaw 16 is disposed on head 14 such that the position of first jaw 16 is adjustable to enable wrench 10 to be adapted for engagement of workpiece heads with different sizes. Second jaw 18 is disposed on head 14 such when workpiece 20 is engaged by first and second jaws 18 and 20, and head 14 is driven by the user to rotate around workpiece 20 in a second direction (clock-wise in FIG. 1) the engagement between workpiece 20 and wrench 10 is released so that wrench 10 ratchets around workpiece 20 in the second direction.

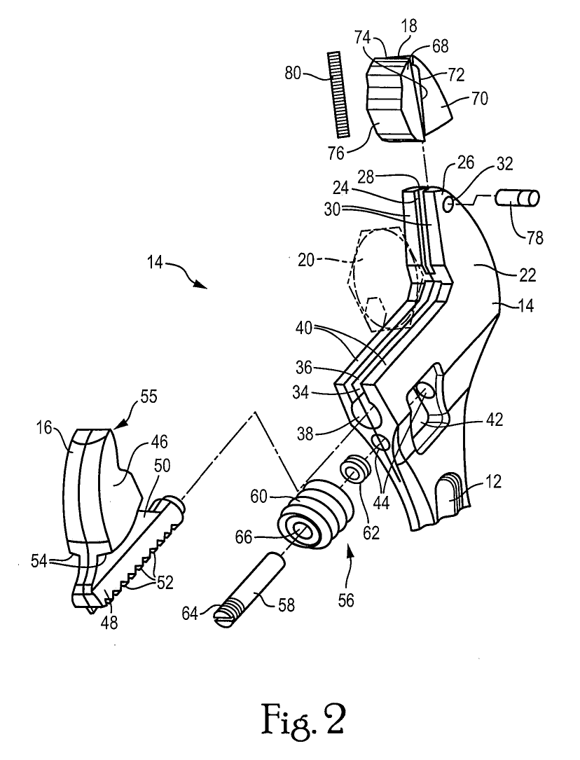

FIG. 2 is an illustration of an exploded view of head 14 of wrench 10. As can be seen in FIG. 2, head 14 is disposed at one end of handle 12. Head 14 includes a jaw support 22 that extends from head 14 away from handle 12. A second jaw track 24 is formed in jaw support 22 as a slot that divides jaw support 22 into a first tab 26 and a second tab 28. Jaw support 22 forms a second jaw guide surface 30 (actually includes a surface formed by each of tabs 26 and 28) that is planar and faces toward first jaw 14 when wrench 10 is assembled. At a distal end of jaw support 22, a conduit 32 is formed that runs through jaw support 22 from one side to the other transverse to the slot formed by track 24 such that the conduit communicates with track 24 and opposing sides of jaw support 22.

A first jaw track 34 is formed in head 14 as a slot with a relatively narrow guide opening 36 that communicates with a wider channel 38. In one embodiment, guide opening 36 is formed as two substantially parallel surfaces that face each other and channel 38 is formed having a circular cross section. In addition to being open at guide opening 36, track 34 is also open on a side of head 14 opposite from jaw support 22. Track 34 runs from the side of head 14 opposite from jaw support 22 toward the base of jaw support 22 (i.e., the point where jaw support 22 connects to the rest of head 14). On either side of guide opening 36 of track 34, first jaw guide surfaces 40 are formed as planar surfaces.

Head 14 further forms a window 42 that passes through head 14 transverse to track 34 such that window 42 communicates with a portion of channel 38. In one embodiment, the cross-section of window 42 is generally rectangular, with chamfered corners. A conduit 44 is formed in head 14 that runs generally parallel to channel 38 and passes through window 42.

First jaw 16 includes a body 46, a threaded runner 48, and an intermediate portion 50 that connects body 46 with runner 48. Runner 48 has an elongated, generally cylindrical shape, and is configured to fit within channel 38. A set of threads 52 are formed on runner 48 opposite intermediate portion 50. Threads 52 are formed as a set of teeth that run along the side of runner 48 opposite intermediate portion 50. Intermediate portion 50 is somewhat narrower than runner 48 or body 46, which enables intermediate portion 50 to fit slidably within guide opening 46. Body 46 forms a pair of surfaces 54 adjacent to either side of intermediate portion 50 that run alongside the length of intermediate portion 50 and sit on first jaw guide surface 40 when first jaw 16 is disposed on head 14. A first workpiece engaging surface 55 is formed by body 46 on a side of body 46 that faces toward jaw support 22 when first jaw 16 is disposed on head 14.

In one embodiment, wrench 10 includes a worm drive 56 that includes an axle 58, a worm 60, and a biasing mechanism 62. Axle 58 is configured to be seated within conduit 44 such that axle 58 runs through window 42 generally parallel with channel 38. Axle 58 includes a set of threads 64 at one end, and is retained within conduit 44 by an engagement between threads 64 and a set of threads formed at the opening of conduit 44. Worm 60 includes a central opening 66 along its axis of rotation, and is disposed within window 42 so that it can be manually rotated by a user about the axis of rotation. Worm 60 is retained within window 42 by axle 58, which is received through central opening 66 of worm 60. Biasing mechanism 62 provides a bias that forces worm 60 toward one side of window 42. This may reduce backlash as worm 60 is rotated by the user.

When first jaw 16 is disposed on head 14 and worm drive 56 is assembled within window 42, the threads of worm 60 are engaged with threads 52 on runner 48. If no rotational force is being applied by a user to worm 60 to rotate about axle 58, this engagement holds first jaw 16 in position on track 34. If the user rotates worm 60 about axle 58, then the threads of worm 60 mesh with threads 52 and drive first jaw 16 to slide along track 34.

As was mentioned above, during operation, surfaces 54 on first jaw 16 sit on first jaw guide surface 34. Thus, as first jaw 16 is driven along track 34 by worm drive 56, first jaw 16 moves along a path that is parallel to guide surface 34. As should be appreciated from FIG. 2, the path of first jaw 16 is further defined by the path of guide opening 36 along guide surface 34. Generally, this path runs from the side of head 14 opposite jaw support 22 toward jaw support 22, and enables the spacing between first jaw 16 and second jaw 18 to be adjusted to accommodate workpieces with different sized heads. Although the path of first jaw 16 is illustrated in FIG. 2 as being a straight line, this is not intended to be limiting.

As can be seen in FIG. 2, second jaw 18 includes a body 68 and a tab 70 extending therefrom on one side. An elongated opening 72 is formed in tab 70 that runs along tab 70. Body 68 forms a pair of surfaces 74 that are adjacent to either side of tab 70. On a side of body 68 opposite from tab 70 and surfaces 74, a second workpiece engaging surface 76 is formed that is adapted to engage the head of workpiece 20 with first workpiece engaging surface 55.

When wrench 10 is assembled, tab 70 is seated slidably within the slot formed by track 24 between tabs 26 and 28 on jaw support 22. In this position, surfaces 74 rest on second jaw guide surface 30. A pin 78 is inserted through conduit 32 on jaw support 22. Pin 78 is also received by opening 72 through tab 70, as the width of opening 72 corresponds to the thickness of pin 78. The reception of pin 78 through opening 72 retains tab 70 within track 24. However, as opening 72 has an elongated shape that runs along tab 70 in a direction that corresponds to second jaw guide surface 30, second jaw 18 is able to slide along second jaw guide surface 30 with pin 78 disposed through opening 72 as pin 78 slides along opening 72.

More particularly, when assembled, second jaw 18 slides along a path parallel to second jaw guide surface 30. The motion of second jaw 18 along the path is between a first position, at which second jaw 18 is closest to the base of jaw support 22 (e.g., as shown in FIG. 1), and a second position, at which second jaw 18 is farthest from the base of jaw support 22. Although the path of second jaw 18 is illustrated in FIG. 2 as being a straight line, this is not intended to be limiting.

As can be appreciated from FIG. 2, the path of first jaw 16 and the path of second jaw 18 are transverse to each other. In the embodiment shown in FIG. 2, an angle between these axes of motion is the same as an angle between first jaw guide surface 40 and second jaw guide surface 30. Due to the different functionalities provided by the mobility of each of first jaw 16 and second jaw 18 (e.g., adjustability of size provided by first jaw 16 and ratcheting provided by second jaw 18), the angle between the axes of motion of jaws 16 and 18 may be approximately 90°. For example, in one embodiment, this angle is between about 75° and about 120°. As another example, in one embodiment, the angle between the axes of motion of the jaws 16 and 18 is between about 80° and about 110°.

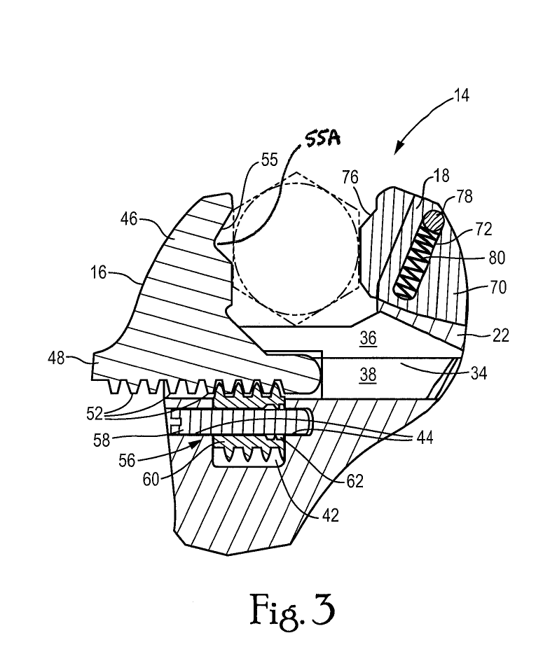

FIG. 2 further illustrates a biasing member 80 that is disposed in wrench 10 to bias second jaw 18 toward the first position (e.g., toward the base of jaw support 22). Biasing member 80 may include a spring, a rubber component, and/or some other elastic component capable of providing a bias to second jaw 18. FIG. 3, which illustrates a section view of head 14, shows how, in one embodiment, biasing member 80 is seated within jaw support 22 to provide the appropriate bias to second jaw 18. More particularly, biasing member 80 is disposed in track 24 within opening 72 formed by tab 70. One end of biasing member 80 engages pin 70, and the other end of biasing member engages an edge of elongated opening 72 at the end of opening 72 closest to the base of jaw support 22. In the view shown in FIG. 3, second jaw 18 is at its first position. If second jaw 18 is slid out of the first position toward the second position (e.g., away from the base of jaw support 22), biasing member 80 is compressed (further than in the view shown in FIG. 3) between pin 78 and the edge of opening 72. As a result of this compression, biasing member 80 provides a bias to tab 70 (at the edge of opening 72) that pushes tab 70 back toward the base of jaw support 22, thereby biasing second jaw 18 toward the first position.

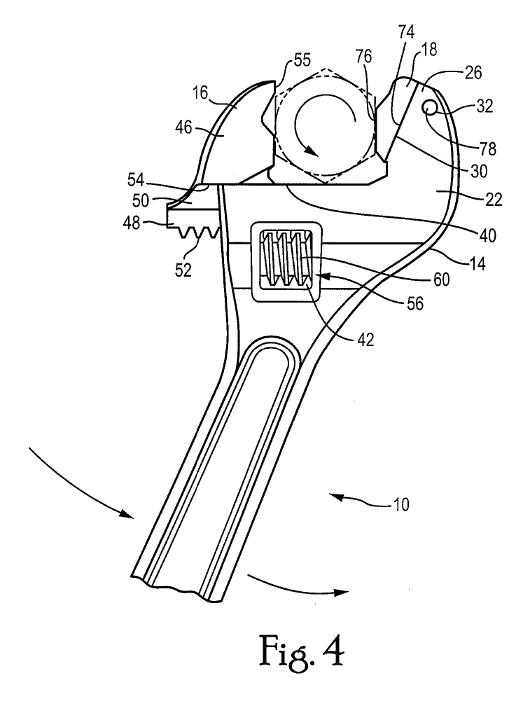

FIG. 4 illustrates wrench 10 driving workpiece 20. As can be appreciated from FIG. 4, if a user engages handle 12 and drives head 14 to rotate about workpiece 20 in a first direction (counter-clockwise in FIG. 4), the head of workpiece 20 applies a force to second jaw 18 at second workpiece engaging surface 76 that would tend to push second jaw 18 toward the base of jaw support 22. Since second jaw 18 is already in the first position (due to the bias applied by biasing member 80), second jaw 18 is not able to slide any further toward the base of jaw support 22. Thus, the engagement between the head of workpiece 20 and second jaw 18 as head 14 is rotated in the first direction around workpiece 20 will cooperate with the engagement between the head of workpiece 20 and first jaw 16 to drive workpiece 20 to rotate in the first direction.

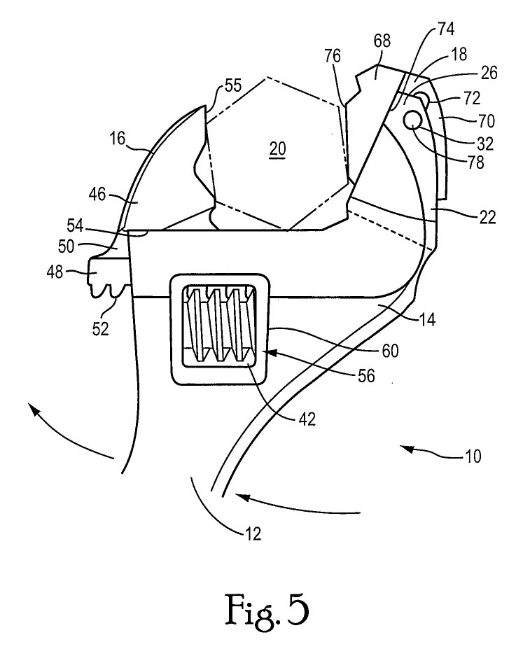

FIG. 5 illustrates wrench 10 ratcheting about workpiece 20. As can be appreciated from FIG. 5, if the user drives head 14 to rotate about workpiece 20 in a second direction (clockwise in FIG. 5), the head of workpiece 20 applies a force to second jaw 18 at second workpiece engaging surface 76 that pushes second jaw 18 away from the base of jaw support 22. As was discussed above, second jaw 18 is slidable along jaw support 22 from its first position toward a second position further away from the base of jaw support 22. Thus, the force applied to second jaw 18 by the head of workpiece 20 at second workpiece engaging surface 76 causes second jaw 18 to slide along its path from its first position toward its second position. As second jaw 18 slides toward its second position, the head of workpiece 20 is released from its engagement with second jaw 18 such that head 14 of wrench 10 can be rotated in the second direction independently from the head of workpiece 20, which remains rotationally fixed.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

1. A wrench adapted to engage a workpiece to drive the workpiece rotationally, the wrench comprising:
a handle;
a head disposed at one end of the handle, the head having a jaw support extending therefrom;
a first jaw disposed on the head, the first jaw forming a first workpiece engaging surface, the first jaw being disposed on the head such that the position of the first jaw is adjustable toward and away from the jaw support along a first path, thereby enabling the wrench to be adapted for engagement with workpieces of different sizes;
a track formed on the jaw support;
a second jaw slidably seated in the track formed on the jaw support to slide along a second path between a first position and a second position, the first position being closer to the handle than the second position and the second path being transverse to the first path;
a biasing member that biases the second jaw toward the first position;
wherein the second jaw forms a second workpiece engaging surface that cooperates with the first workpiece engaging surface to grasp a workpiece therebetween and drive the workpiece in a first rotational direction if the head is driven in the first rotational direction by the handle, and wherein if the head is driven by the handle in a second rotational direction the engagement between the second jaw and the workpiece applies a force to the second jaw that slides the second jaw from the first position toward the second position, which enables the head to be rotated independently from the workpiece in the second rotational direction.

2. The wrench of claim 1, wherein the first path is approximately perpendicular to the second path.

3. The wrench of claim 2, wherein an angle between the first path and the second path is between about 80° and about 110°.

4. The wrench of claim 2, wherein an angle between the first path and the second path is between about 75° and about 120°.

5. The wrench of claim 1, wherein the track is a slot formed in the jaw support from a distal end of the jaw support toward an interface between the jaw support and the rest of the head.

6. The wrench of claim 5, wherein the second jaw comprises a tab that is slidably secured within the slot to enable that second jaw to slide on the jaw support along the second path.

7. The wrench of claim 1, further comprising a worm drive rotationally mounted in the head, wherein the first jaw comprises a set of threads that are engaged with the worm drive such that as the worm drive is rotated, the worm drive applies a force to the threads that causes the first jaw to slide along the first path.

8. The wrench of claim 1, wherein the first rotational direction is a tightening direction and the second rotational direction is a loosening direction.

9. A wrench adapted to engage a workpiece to drive the workpiece rotationally, the wrench comprising:
a handle;
a head disposed at one end of the handle, the head having a jaw support extending therefrom;
a first jaw disposed on the head, the first jaw forming a first workpiece engaging surface;
a slot formed in a surface of the jaw support;
a conduit formed in the jaw support on each side of the slot such that the conduit creates a passage from one side of the jaw support to another side of the jaw support, the passage communicating with the slot;
a pin seated in the conduit formed in the jaw support, the pin passing transversely through the slot;
a second jaw having a tab with an opening formed therein, the tab of the second jaw being seated in the slot formed on the jaw support such that the pin passes through the opening formed in the tab to retain the tab within the slot, wherein the opening is formed in the tab to enable the second jaw to slide along the jaw support between a first position and a second position, the first position being closer to the handle than the second position;
a biasing member that biases the second jaw toward the first position;
wherein the second jaw forms a second workpiece engaging surface that cooperates with the first workpiece engaging surface to grasp a workpiece therebetween and drive the workpiece in a first rotational direction if the head is driven in the first rotational direction by the handle, and wherein if the head is driven by the handle in a second rotational direction, the engagement between the second jaw and the workpiece applies a force to the second jaw that slides the second jaw from the first position toward the second position, which enables the head to be rotated independently from the workpiece in the second rotational direction.

10. The wrench of claim 9, wherein the position of the first jaw on the head is adjustable to accommodate workpieces of different sizes.

11. The wrench of claim 10, wherein the position of the first jaw on the head is adjustable along a first path, and wherein the second jaw is slidable between the first position and the second position along a second path that is transverse to the first path.

12. The wrench of claim 11, wherein the path of the first jaw and the path of the second jaw form an angle of between about 75° and about 120°

13. The wrench of claim 10, further comprising a worm drive rotationally mounted in the head, wherein the first jaw comprises a set of threads that are engaged with the worm drive such that as the worm drive is rotated, the worm drive applies a force to the threads that causes the position of the first jaw be adjusted.

14. The wrench of claim 9, wherein the biasing member is disposed within the opening in the tab of the second jaw between the pin and an edge of the opening such that motion of the second jaw toward the second position compresses the biasing member between the pin and the edge of the opening.

15. The wrench of claim 9, wherein the first rotational direction is a tightening direction and the second rotational direction is a loosening direction.

16. The wrench of claim 1, wherein the first workpiece engaging surface has a recess configured to receive a corner of a workpiece.

17. The wrench of claim 9, wherein the first workpiece engaging surface has a recess configured to receive a corner of a workpiece.
